(19) United States
(12) Patent Application Publication
(10) Pub. No.: US 2012/0114891 A1
(43) Pub. Date: May 10, 2012

(54) Sticky note and post it note in a rolled form

(75) Inventor: L. David Smith, North Liberty, IN (US)

(73) Assignees: Lyn David Smith, North Liberty, IN (US); Thomas Joseph Dolly, Mishawaka, IN (US); Glen Warren Smith, North Liberty, IN (US)

(21) Appl. No.: 12/925,984

(22) Filed: Nov. 4, 2010

(51) Int. Cl. B32B 33/00

(52) U.S. Cl. 428/40.1; 156/184

(57) ABSTRACT

This invention is a special roll of sticky note, post it note or one note paper or sheets created for a specific function. The roll of sticky note, post it note or one note sheets are to be fed into a special printer specifically created to print on this specific roll of sticky note, post it note or one note sheets. This special printer can at any given time print messages and reminders on each individual sticky note, post it note or one note sheet. The roll of sticky note, post it note or one note sheets well unroll inside the special printer allowing multiple messages and reminders that can be printed. Each individual sticky note, post it note or one note sheet with said message or reminder printed on them can simply be peeled off from the rest of the sticky note, post it note or one note sheets and relocated to the desired location without disturbing the rest or the special printer.

Other Patent Documents

| | | |
|---|---|---|
| US Pat. H377 | (unknown) | Releasable adhesive pads |
| U.S. Pat. No. 2,215,995 | September 1940 | (unknown) |
| U.S. Pat. No. 3,691,140 | September 1972 | (unknown) |
| U.S. Pat. No. 4,587,152 | May 6, 1986 | Residuelessly redetachable contact-adhesive sheetlike struct |
| U.S. Pat. No. 4,599,265 | Jul. 8, 1986 | Removable pressure-sensitive adhesive tape |
| U.S. Pat. No. 4,680,210 | Jul. 14, 1987 | Repositionable directional markers |
| U.S. Pat. No. 4,930,812 | Jun. 5, 1990 | Adhesive label or leaflet assemblies |
| U.S. Pat. No. 4,971,364 | Nov. 20, 1990 | Label-providing log for fascmile transmissions and method |
| U.S. Pat. No. 4,980,212 | Dec. 25, 1990 | Self-holding drafting paper |
| U.S. Pat. No. 4,995,641 | Feb. 26, 1991 | Note pad for entry into permanent records |
| U.S. Pat. No. 5,011,186 | Apr. 30, 1991 | Hexagonal pad |
| U.S. Pat. No. 5,029,903 | Jul. 9, 1991 | Wallet size note pack |
| U.S. Pat. No. 5,087,223 | Feb. 11, 1992 | Multiple ply assembly |
| U.S. Pat. No. 5,299,833 | Apr. 5, 1994 | Paper sheets with pressure sensitive adhesive forming an ea |
| U.S. Pat. No. 5,324,078 | Jun. 28, 1994 | Removable linerless label zigzag and shingled constructions |
| U.S. Pat. No. 5,328,409 | Jul. 12, 1994 | Note caddy |
| U.S. Pat. No. 5,370,420 | Dec. 6, 1994 | Pressure sensitive label for high speed laser printers |
| U.S. Pat. No. 5,399,403 | Mar. 21, 1995 | Labels and manufacture thereof |
| U.S. Pat. No. 5,418,026 | May 23, 1995 | Curl-resistant printing sheet for labels and tags |
| U.S. Pat. No. 5,782,494 | Apr. 23, 1996 | Desktop Printers Notes |
| U.S. Pat. No. 11/648,736 | Jan. 3, 2007 | Pre-printed sticky notes and methods of use to send messag |
| U.S. Pat. No. 10/950,983 | Sep. 27, 2004 | Adhesive notepad having sheets with reduced flagging chara |
| U.S. Pat. No. 10/947,728 | Sep. 23, 2004 | Adhesive note with multiple attachment points |
| U.S. Pat. No. 10/537,469 | Nov. 11, 2003 | Self-adhesive article |
| U.S. Pat. No. 11/979,696 | Nov. 7, 2007 | Paper with adhesive |
| U.S. Pat. No. 6,296,932 | Dec. 14, 1998 | Microsphere adhesive coated article for use with coated pap |

### BACKGROUND OF THE INVENTION

The background of this invention comes from the fact that people need notes in which to remind them of responsibilities, chores, ideas, and other miscellanies items. They right write them down on sticky note pads or post it pads and then stick them where ever it takes to remind them what they need to be reminded of. Sticky note pads and post it pads have one strip of sticky glue that allows them not only to be stuck together but to enable them to be stuck on different surfaces. The sticky notes are stacked together in pads so people write a reminder on the top sheet and then peel it off and then stick it where it needs to be stuck.

This invention also has to do with the today's age of technology and communication. With this invention people can print themselves a reminder note without even being where the sticky note pad or post it pad is. With this special invention printer we need a special paper application which can be fed through the printer. To do so we need sticky note and post it note sheets to be in a roll form. The invention in this patent is sticky notes and post it notes in a roll form only.

This invention also allows people to print the same messages, reminders, or notes on multiple on the sticky note and post it pads. This would let people to peel off the sticky note or post it note the sheet and stick them where necessary and give one or more than one person the same message.

### BRIEF SUMMARY OF INVENTION

This invention is a special type of sticky note and post it note paper application. The sticky notes and post it notes are placed in a roll form that shall be fed in a special printer. The sticky notes and post it notes shall be placed in a tight roll with any number of said sticky notes and post it notes in each roll. The sticky note or post it note paper then can be fed through a special printer allowing the user of this printer to be able to print any reminder on said sticky note or post it note paper. At which point the user of the special printer can then peal each sticky note or post it note from the special printer or special roll of said sticky notes or post it notes and then placing said sticky note or post it note with the reminder printed on them in any desired location.

### DESCRIPTION OF DRAWINGS

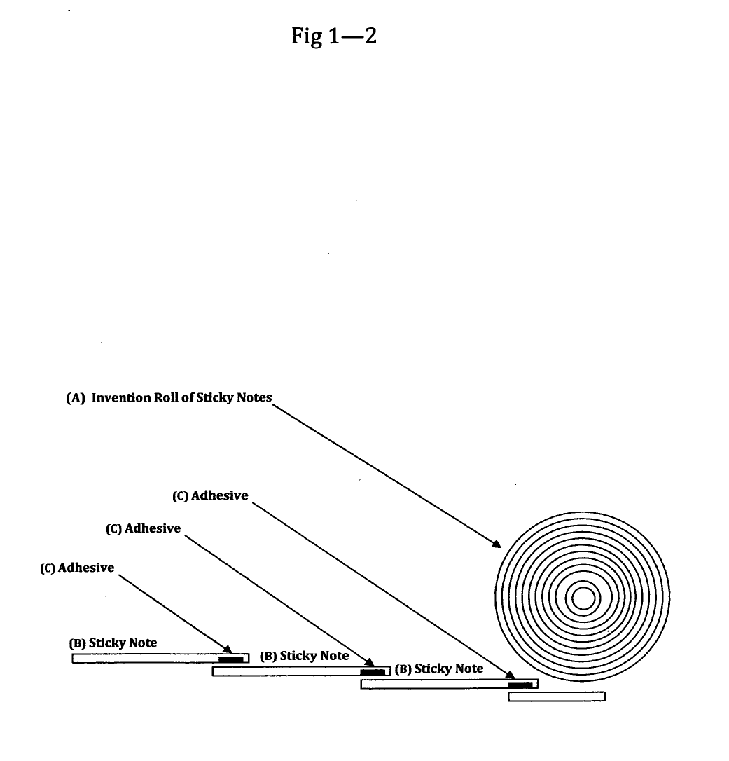

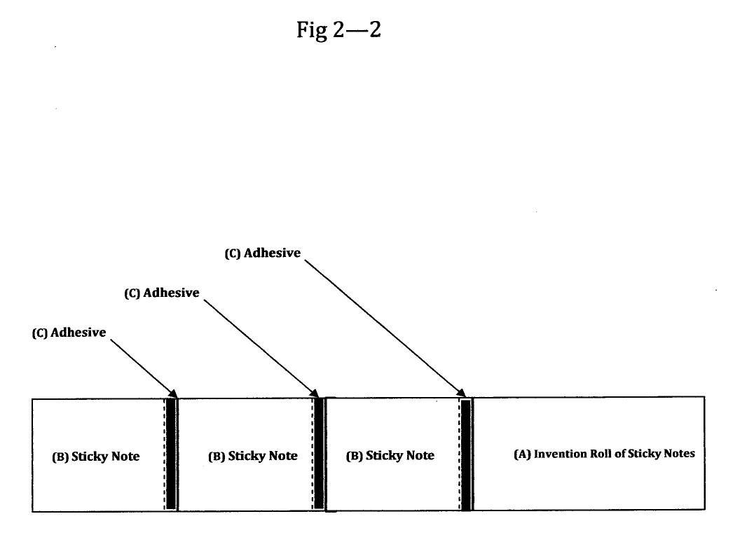

Drawing number one (FIG. 1-2): This drawing shows a side view of the Invention Roll of Sticky notes or Post it Notes (A) (FIG. 1-2) which incases any number of sticky notes or post it notes stuck together in a specific manner. This drawing also shows three, sticky notes or post it notes sticking out of the Invention Roll of Sticky Notes or Post it Notes.(B) (FIG. 1-2) stuck and placed with an adhesive (C) (FIG. 1-2) in the specific manner needed. This drawing also shows how the Invention Roll of Sticky Notes or Post it Notes (A) (FIG. 1-2) shall be tightly rolled to allow usability.

Drawing number two (FIG. 2-2): This drawing shows an over view of the Invention Roll of Sticky Notes or Post it Notes (A) (FIG. 2-2) tightly rolled with any number of sticky notes or post it notes. This drawing also shows three sticky notes or post it notes (B) (FIG. 2-2) unrolled from said Invention Roll of Sticky Notes or Post it Notes, which shows how each said sticky note or post it note shall be placed or stuck together with an adhesive (C) (FIG. 2-2).

### DESCRIPTION OF THE INVENTION

The invention is a specially designed print paper strictly for printing only sticky note, post it note, one note or any other kind of small note paper with a sticky edge. These sticky notes or post it notes, or one notes paper or sheets are used for reminders or messages and are capable of being stuck or placed almost anywhere desired. The invention is the sticky note, post it note or one note paper, or sheets manufactured in a roll so said roll of can then be placed in a specific printer.

The invention roll of sticky note, post it note, or one note paper or sheets shall be in a roll form with any number of said sticky notes, post it notes, or one notes. The total number of said sticky note, post it note, or one note sheets shall be determined with each different specific application. The sticky note, post it note, or one note sheets shall be placed or stacked in a specific way that allows each sticky note, post it note, or one note sheet to be removed or peeled off the top of the next sticky note, post it note, or one note sheet that's following the prior one which was just peeled off.

The invention roll of sticky note, post it note, or one note paper or sheets shall be tightly rolled so each said invention roll of sticky note, post it note, or one note paper sheets can be load or placed in the specific designed printer. The invention roll of sticky note, post it note, or one note paper sheets can then be fed through and by the specifically designed printer. The specifically designed printer shall be able to print off any number of reminders or messages on each of the single sticky note, post it note, or one note paper or sheet. At that given time each individual sticky note, post it note, or one note paper or sheet with said message or reminder can simply be removed or peel off.

Each invention roll of sticky note, post it note, or one note paper or sheets shall be one continuous roll so multiple reminders or messages can be printed on each individual sticky note, post it note, or one note paper sheet for any number of different reminders or messages desired can be printed. Each sticky note, post it note, or one note paper or sheet shall be stuck together allowing one long run of said sticky note, post it note, or one note paper sheets enabling the ability to roll up said long run of said sticky note, post it note, or one note paper sheets creating the invention roll of sticky note, post it note, or one note paper or sheets.

This invention is strictly compiling any number of sticky note, post it note, or one note paper or sheets and putting them in a specific roll and not in a pad Allowing the specific use of the invention roll of sticky note, post it note, or one note paper or sheets. This invention is strictly the roll of sticky note, post it note, or one note paper or sheets and not the sticky note, post it note, or one note paper themselves. The invention specific roll of sticky note, post it note, or one note paper or sheets with the concept and design to be able to provide the specific function of each individual invention roll of sticky note, post it note, or one note paper or sheets.

The invention roll of sticky note, post it note, or one note paper or sheets shall be placed or stuck together with adhesive in a specific way to allow a specific function with the said invention roll of sticky note, post it note, or one note paper or sheets tightly rolled to allow a specific function whether the said invention roll of sticky note, post it note, or one note paper or sheets is rolled differently as long as the specific function is met. The invention roll of sticky note, post it note, or one note paper or sheets can be unrolled with the paper or sheets of sticky notes, post it notes, or one notes unrolling from underneath of said invention roll of sticky note, post it note, or one note paper or sheets. The invention roll of sticky note, post it note, or one note paper or sheets can be unrolled with the paper or sheets of sticky notes, post it notes, or one notes unrolling from above of said invention roll of sticky note, post it note, or one note paper or sheets.

What we claim as our invention is:

1. A specific roll of paper or sheets containing any number of sticky notes, post it notes, or one notes placed together or stuck together with an adhesive in a specific manner to allow each said sticky note, post it note, or one note sheet to be processed through a specific printer with a specific function and then relocated.

2. The method of claim 1 wherein further the specific roll of sticky note, post it note, or one note sheets shall be tightly rolled with each individual roll meeting any desired diameter depending on said roll of sticky note, post it note, or one note sheets specific purpose or function.

3. The method of claim 1 wherein further the specific roll of sticky note, post it note, or one note sheets containing any number of sticky note, post it note, or one note sheets.

4. The method of claim 3, wherein further the specific roll of sticky note, post it note, or one note sheets containing individual sticky note, post it note, or one note sheets is that each specific said sticky note, post it note, or one note sheet can be of different sizes in length depending on desired function.

5. The method of claim 1, further wherein the specific roll of sticky note, post it note, or one note sheets can be manufactured at any given width depending on the specific purpose or function of said specific roll of sticky note, post it note, or one note paper or sheets.

6. The method of claim 1, further compromising: the specific roll of sticky note, post it note, or one note sheets can be manufactured with each individual said sticky note, post it note, or one note sheet or the entire roll of sticky note, post it note, or one note sheets in any one color, multiple colors, patterns, design, or pictures.

7. The method of claim 4, further compromising: the specific roll of sticky note, post it note, or one note sheets containing individual sticky note, post it note, or one note sheets is that each specific said sticky note, post it note, or one note sheet can be manufactured as one complete individual note, post it note, or one note sheet compiling the entire specific roll in one complete length with multiple locations of adhesive throughout entire of said roll depending on desired function. This can also allow separation of each individual sticky note, post it note, or one note sheet by tearing or cutting.

8. The method of claim 1, wherein further the specific roll of sticky note, post it note, or one note sheets containing individual sticky note, post it note, or one note sheets is that each specific said sticky note, post it note, or one note sheet can be created in different shapes, patterns, or items.

9. The method of claim 1, wherein further the specific roll of sticky note, post it note, or one note sheets containing individual sticky note, post it note, or one note sheets is that each specific said sticky note, post it note, or one note sheet can be created with different amounts of adhesive or different number of adhesive strips depending on their functions.

10. The method of claim 1, wherein further the specific roll of sticky note, post it note, or one note sheets containing individual sticky note, post it note, or one note sheets is that each specific said sticky note, post it note, or one note sheet can be created with different grades of sticky note, post it note, or one note paper or sheets, different make up of sticky note, post it note, or one note paper or sheets, or different sticky note, post it note, or one note paper or sheet thickness.

11. The method of claim 1, wherein further the specific roll of sticky note, post it note, or one note sheets containing individual sticky note, post it note, or one note sheets is that each specific said sticky note, post it note, or one note sheet can be created with a continuous backing paper or miscellaneous sheet holding the said roll of sticky note, post it note, or one note sheets together preventing the sticky note, post it note, or one note sheets from coming apart at any given time.

12. The method of claim 1, wherein further the specific roll of sticky note, post it note, or one note sheets containing individual sticky note, post it note, or one note sheets is that each specific said sticky note, post it note, or one note sheet can be created with perforations per each individual sticky note, post it note, or one note sheet instead of sticking or attaching each individual sticky note, post it note, or one note sheet to one another. Perforations can be at any number of different locations depending on use and function.
